(19) United States
(12) Patent Application Publication
(10) Pub. No.: US 2014/0101140 A1
(43) Pub. Date: Apr. 10, 2014

(54) METHOD AND SYSTEM FOR INFORMATION RETRIEVAL AND PROCESSING

(71) Applicant: Commonwealth Scientific and Industrial Research Organisation, Campbell (AU)

(72) Inventor: Peter Richard BAILEY, O'Connor (AU)

(73) Assignee: Commonwealth Scientific and Industrial Research Organisation, Campbell (AU)

(21) Appl. No.: 14/056,539

(22) Filed: Oct. 17, 2013

Related U.S. Application Data
(63) Continuation of application No. 12/739,924, filed on Aug. 24, 2010, now abandoned.

(30) Foreign Application Priority Data
Oct. 26, 2007 (AU) 2007905892

(51) Int. Cl. G06F 17/30

(52) U.S. Cl. CPC G06F 17/30554
USPC 707/722; 707/770

(57) ABSTRACT

A computer-implemented system for the retrieval and manipulation of information available via, an information network includes an information retrieval and processing component. The information retrieval and processing component includes: (a) search query means for conducting a search of the information network to obtain references to the information relevant to a search query; (b) information retrieval means for retrieving information available from sources on the information network, and an information store, for storage of retrieved information; and (c) processing means for processing of information retrieved from sources on the information network, and of information stored in the information store, to produce corresponding processed information. The system includes a cell-based user interface, and an intermediate storage layer, which permits a user, who may be unfamiliar with sophisticated computer programming languages, to develop automated processes for information transfer and manipulation based on present and historical information available via the information network.

### FIELD OF THE INVENTION

This application is a Continuation of Ser. No. 12/739,924, filed 24 Aug. 2010, which is a National Stage Application of PCT/AU2008/001563, filed 23 Oct. 2008, which claims benefit of Ser. No. 2007905892, filed 26 Oct. 2007 in Australia and which application(s) are incorporated herein by reference. To the extent appropriate, a claim of priority is made to each of the above disclosed applications.

The present invention relates generally to on-line information retrieval and processing, and more particularly to methods, systems and computer apparatus providing improvements in relation to searching, retrieval and manipulation of information available via networks such as the Internet.

### BACKGROUND OF THE INVENTION

Modern information systems, including large databases, the Internet generally, and the World Wide Web (“Web”) in particular, contain huge quantities of information. However, locating, retrieving and manipulating information of particular interest remains a challenging problem. In response to this need, various strategies for locating and ranking relevant information, generally in response to specific search queries provided by users, have been developed. An important application of such methods is that of searching for information on the Web, and a number of Web search engines, including Google, Yahoo, AltaVista, Lycos and so forth, are well-known to Internet users around the world.

The function of such search engines is to identify and rank information, most commonly in the form of Web pages, that is of interest to a user. While Web searching, as noted, is presently the most common application, search engines that are optimised for image searching, searching within Web logs (“blogs”), and searching of syndicated services, such as news services, distributed using technologies such as RSS (“Really Simple Syndication”) or Atom, have also been developed.

For the majority of casual users, the search process commences by providing a search query, which is typically a list of search terms. The search engine then attempts to identify information likely to be of interest to the user, based upon the search query. Information (eg Web pages) that is considered relevant to the search query are generally known as “hits”. Search engines typically make some attempt to rank the hits in order of relevance, before returning a corresponding list of documents to the user. Despite the relevant unsophistication of this simple interface, such search engines, along with supporting software such as Web browsers and RSS/Atom feed readers, provide [symbol] m said operations.

[symbol]

the primary means of access to human-readable information available on the Internet.

Less apparent to casual users of search engines is the fact that most such systems also provide an Application Programming Interface (API) to the search engine's basic query functionality. The API enables the services provided by the search engine to be utilised by other programs developed for use on the Internet. Corresponding APIs are also available for programmatically accessing information feeds, such as RSS or Atom feeds, published by Web sites or other services. Utilising these APIs however, requires that the user possess relatively sophisticated technical knowledge and software development skills.

Once information has been identified, for example on the Internet, the options available for manipulating the results are also limited. Users may save Web pages, or copy and paste selected information into other documents. Alternatively, automated processing and manipulation of information is possible in principle, however again requires a generally high level of technical skill, and knowledge of relevant programming languages.

Another limitation of existing information searching, retrieval and processing systems of the aforementioned kind, is that users are generally able to interact with search engines, feed readers and the like, only “in the moment.” That is, for example, the results of a Web search depend upon the current content of the cache, or corpus, of Web pages currently held by the search service provider. These are continuously, and automatically, updated by processes such as “Web crawlers” which traverse the entire Web identifying updated Web pages, and replacing, removing and/or augmenting the outdated copies in the search service cache or corpus. A search conducted on one particular day may therefore produce different results from the same search query executed at an earlier or later time. While services such as “the Wayback Machine” (web.archive.org) store and provide access to archived copies of on-line information, these do not provide the rich searching tools available in relation to the “live” Internet. More particularly, it is not possible for users to conduct complete searches in relation to information available on the Internet as at a particular date, or to compare the results of such searches readily with the results of equivalent searches conducted on a different date.

There exists a class of users, generally categorisable as “knowledge workers”, who are neither casual users, nor skilled programmers, but who have a real need for a richer and more sophisticated set of searching tools. For such users, it would be desirable to provide systems and methods for interacting with a search engine or and information feed in a programmatic way, without the need for a complex programming language. It would also be desirable to enable knowledge workers to manipulate the results of search engine queries and/or information feeds for downstream processing and analysis. Knowledge workers may also desire to carry out sophisticated computational linguistic operations, such as summarisation or sentence selection, on document texts. It may additionally be desirable to enable knowledge workers to compare historical information in relation to the results of searches conducted on different dates.

It is therefore an object of the present invention to address the aforementioned desires.

### SUMMARY OF THE INVENTION

In one aspect, the present invention provides a computer-implemented system for the retrieval and manipulation of information available via an information network, the system including:

an information retrieval and processing component, which includes:
search query means for conducting a search of the information network to obtain references to information relevant to a search query;
information retrieval means for retrieving information available from sources on the information network, corresponding with said references;
an information store, for storage of retrieved information; and
processing means for processing of information retrieved from said sources on the information network and of information stored in said information store, to produce corresponding processed information; and

a user interface having an array of input/output cells, which is adapted to enable a user to provide input into one or more of said cells for directing operations of the information retrieval and processing component, and to display within one or more of said cells information resulting from said operations.

Embodiments of the invention therefore provide, in general, a novel interface for interacting with search engines or information feeds. Advantageously, search engine results, information feed entries, and the like are transferred into a cell-based user interface for display and subsequent manipulation. The information store, described in preferred embodiments as an intermediate storage layer, is used to retain the results, both for caching purposes, and for subsequent manipulation and historical access.

The system is such, in at least preferred embodiments, that it permits a knowledge worker or other user, who is not familiar with sophisticated computer programming languages but whose searching, retrieval and manipulation needs exceed those of casual users, effectively to develop their own “programs” for information transfer and manipulation applications following a lesser period of training.

In preferred embodiments, the search query means, information retrieval means, processing means, and user interface are implemented utilising appropriate software components, adapted for these purposes, and executable upon a suitable computer hardware platform. For example, in one particular embodiment, the various means making up the system are implemented as software extensions to a commercially available spreadsheet application, executing within a conventional personal computing environment.

More particularly, in another aspect the invention provides an apparatus for the retrieval and manipulation of information available via an information network, the apparatus including:

at least one microprocessor;

at least one memory/storage device operatively associated with the microprocessor;

at least one network interface device providing a connection to the information network and operatively associated with the microprocessor;

at least one user input device operatively associated with the microprocessor; and

at least one display device operatively associated with the microprocessor,

wherein the memory/storage device includes executable instruction code which, when executed by the microprocessor, causes the apparatus to implement the steps of:

displaying, on said display device, a graphical user interface having an array of input/output cells;

receiving input of a user via said user input device, said input being associated with one or more of said cells, and including instructions relating to the retrieval and processing of information available via the information network;

responsive to said user input, performing one or more information retrieval or processing operations selected form the group consisting of:
conducting a search of the information network to obtain references to information relevant to a search query of the user;
retrieving information from sources on the information network corresponding with said references;
retrieving information from the information store corresponding with said references;
storing information retrieved from sources on the information network within the information store; and
processing information retrieved from said sources on the information network or information stored in said information store, to produce corresponding processed information; and

displaying within one or more of said cells information resulting from said retrieval or processing operations.

According to preferred embodiments, the array of input/output cells includes at least a two-dimensional matrix of cells. In this respect, the user interface may be compared to that of a conventional spreadsheet application, providing the advantage of familiarity to prospective users. Additional dimensions of storage cells may also be provided. For example, a three-dimensional array may effectively be provided via a workbook/worksheet model, wherein the overall array consists of a plurality of parallel two-dimensional matrices.

The processing means and steps are preferably adapted to process information associated with cells in the array, which may include information available via the information network, information available in the information store, and/or processed information obtained through the action of processing of retrieved and/or stored information in accordance with user input in various cells of the array. As will be appreciated, therefore, there may exist interdependencies between cells, as known in relation to conventional spreadsheet applications. It is accordingly advantageous to provide an execution engine effecting steps for determining an appropriate evaluation order arising from the dependencies between user processing instructions and other cross-referenced data in cells within the array, and then to repeatedly execute the user instructions in the evaluation order required until no more execution is possible.

Preferably, information retrieval includes downloading the contents of search results to the information store. It is particularly preferred that a timestamp, corresponding with the date and time of retrieval, is associated with the stored information. In accordance with preferred embodiments, the information associated with cells in the array therefore corresponds with a particular date and time of retrieval, and the information may subsequently be manipulated relative to the timestamp, for historical and comparative purposes.

According to particularly preferred embodiments, the user input provided within each cell may include instructions in the form of directions to execute specified named functions, said functions preferably receiving one or more parameters, wherein the parameters may include references to other cells, or to the content of other cells. The functions may provide a time parameter, whereby referenced information is retrieved, accessed or processed corresponding with a specified time, and in accordance with an associated time stamp of stored information. Where required, preferred embodiments of the inventive system and apparatus automatically retrieve, access and/or process required information either from the information network (ie “live” information), or from the information store (ie previously retrieved information having an associated, earlier, timestamp).

Information sources that may be retrieved and manipulated utilising various embodiments of the invention include Web pages, blog entries, RSS or Atom feeds (eg news articles), and individually addressable documents, such as those stored on a connected local hard drive, network information resource, or other storage device.

In a further aspect, the invention provides a computer-implemented method for retrieval and manipulation of information available via an information network, the method including the steps of:

providing an information store for storage of information retrieved from the information network;

providing a user interface having an array of input/output cells;

receiving input of a user into one or more of said cells, said input including instructions relating to the retrieval and processing of information available via the information network;

responsive to said user input, performing one or more information retrieval or processing operations selected from the group consisting of:
conducting a search of the information network to obtain references to information relevant to a search query of the user;
retrieving information from sources on the information network corresponding with said references;
retrieving information from the information store corresponding with said references;
storing information retrieved from sources on the information network within the information store; and
processing information retrieved from said sources on the information network or information stored in said information store, to produce corresponding processed information; and

displaying within one or more of said cells information resulting from said retrieval or processing operations.

Further preferred features and advantages of the present invention will be apparent to those skilled in the art from the following description of a preferred embodiment of the invention, which should not be considered to be limiting of the scope of the invention as defined in any of the preceding statements, or in the claims appended hereto.

### BRIEF DESCRIPTION OF THE DRAWINGS

Further embodiments of the invention are described with reference to the accompanying drawings, in which like reference numerals refer to like features, and wherein:

FIG. 1 is a schematic diagram of an information network illustrating a preferred embodiment of the present invention;

FIG. 2 is a block diagram illustrating a software architecture according to a preferred embodiment of the invention:

FIG. 3 is a flowchart illustrating a preferred method for retrieval and manipulation of information according to a preferred embodiment of the invention;

FIGS. 4a to 4d are screen shots illustrating an example of interacting with search results;

FIGS. 5a to 5d are screen shots illustrating an example of interacting with feed items;

FIGS. 6a to 6e are screen shots illustrating an example of interacting with feed items over time; and

FIGS. 7a to 7e are screen shots illustrating an example of interacting with search results over time.

### DETAILED DESCRIPTION OF PREFERRED EMBODIMENT

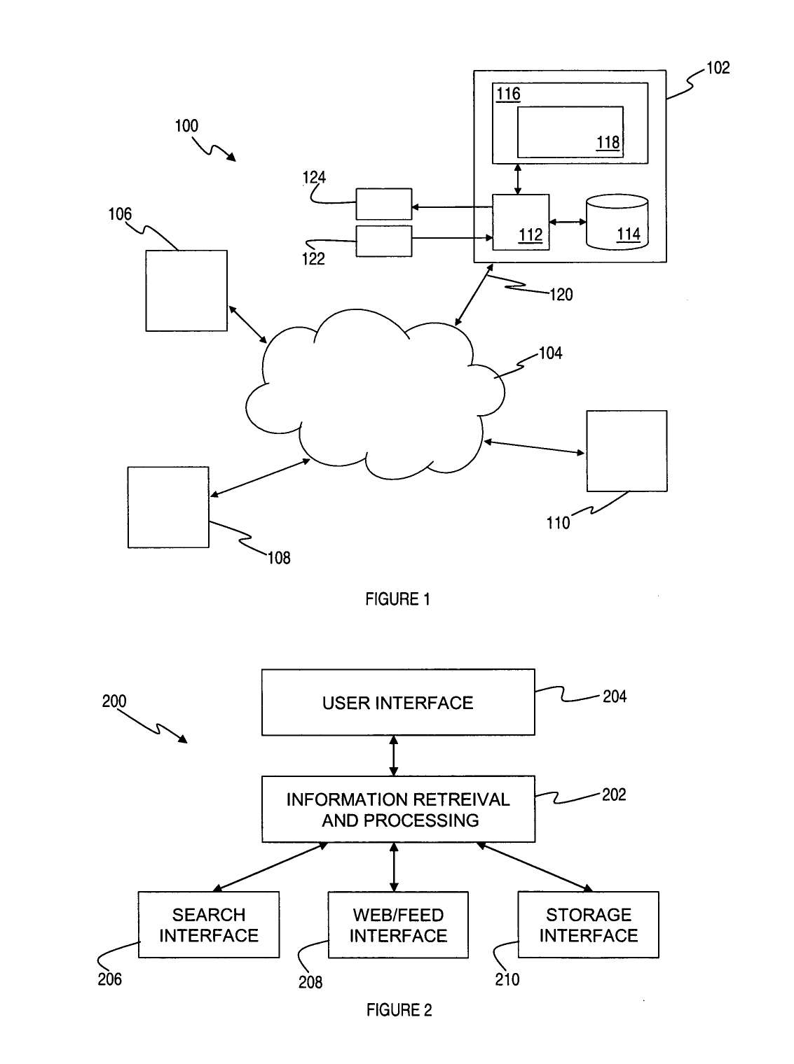

FIG. 1 illustrates schematically an information system 100 in which a preferred embodiment of the invention is implemented. The system 100 includes a user computer 102 which is connected to an information network 104, which by way of example is the Internet. It will be appreciated however, that the invention is equally applicable to other information networks, including intranets and/or proprietary information systems.

As will be appreciated, numerous other terminals, devices and servers are also connected to the Internet 104, including search engine 106, feed (eg RSS or Atom) server 108, and Web server 110. It will be appreciated that FIG. 1 depicts the system 100 schematically only, and is not intended to limit the technology employed in the servers, user terminals and/or communications links. The various devices connected to the network 104 may be wired or wireless devices, and the connections to the network may utilise various technologies and bandwidths. For example, applicable devices include (without limitation) PCs with wired (eg LAN, cable, ADSL, dialup) or wireless (eg WLAN, cellular) connections. The protocols and interfaces between devices, such as user terminals, PCs and network servers, may also vary according to available technologies, and include (again without limitation) wired TCP/IP (Internet) protocols, GPRS, WAP and/or 3G protocols, and/or proprietary communications protocols.

In the exemplary case in which the network 104 is the Internet, vast quantities of information are available to the user of computer 102 from servers, and particularly Web servers, eg 110, and feed servers, eg 108, located throughout the world. A knowledge worker, being an exemplary user of the computer 102, desires to access this information, search and retrieve relevant materials, and conduct further information processing operations.

To this end, the computer 102 embodies a computer-implemented system for the retrieval and manipulation of information via the Internet 104, in accordance with the present invention. The computer 102 includes at least one processor 112, and further includes, or is associated with, a high capacity, non-volatile memory/storage device 114, such as one or more hard-disk drives. According to preferred embodiments of the invention, the storage device 114 is used to maintain an information store, the details and purpose of which are described in greater detail below. The storage 114 may also contain other programs and data required for the operation of the computer 102, and the implementation and operation of the information processing system according to an embodiment of the invention.

The computer 102 further includes an additional storage medium 116, typically being a suitable type of memory, such as random access memory, for containing program instructions and transient data relating to the operation of the computer 102. In particular, the memory 116 contains a body of program instructions 118 implementing the functions of an information retrieval and manipulation system in accordance with a preferred embodiment of the present invention. The body of program instructions 118 includes instructions for providing a user interface, as well as for the retrieval, storage, and processing of information available via the Internet 104. Further details of these functions are described below.

The processor 112 is further interfaced to at least one associated user input device 122, such as a keyboard and/or mouse, enabling a user, such as a knowledge worker, to operate the system. A display device 124, to which the processor 112 is also interfaced, provides visual output to the user. A suitable network interface 120, for example a LAN or WLAN interface, enables the processor 112 to access information via the Internet 104. The technical details of interfacing between the processor 112 of the computer 102, and its various peripheral devices, including the input device 122, display device 124 and network interface 120, will be familiar to persons skilled in the art.

Turning now to FIG. 2, there is illustrated a block diagram 200 of a software architecture, implemented by the body of program instructions 118, according to an embodiment of the invention. An information retrieval and processing software component 202 embodies and implements search query means for conducting a search of the information network via an interface 206 to a search engine, eg 106. The software component 202 is thus able to utilise a search engine 106 to obtain references to information relevant to a search query of a user. The interface 206 may enable access to any one or more search engine services available via the Internet 104.

The software component 202 further embodies and implements information retrieval means for retrieving information available from sources on the information network, corresponding with references retrieved via the search engine interface 206. In particular, one or more interfaces 208 may be provided for accessing resources, such as Web servers and RSS/Atom feeds. The function of the interfaces 208 is accordingly to provide implementations of the appropriate protocols for accessing such information resources, and retrieving information therefrom. Retrieved information may also be stored to an associated local storage device, eg 114, via an appropriate software interface 220.

The software component 202 further embodies and implements processing means for processing of information retrieved from the Internet 104 via interfaces 208, and of information stored in the storage device 114. Details of the types of processing available in exemplary embodiments of the invention are discussed in greater detail below.

The software component 202 is further adapted and configured to generate a user interface 204, including an array of input/output cells, and which is adapted to enable a user to provide input, such as search, retrieval and/or processing instructions, into one or more of the cells. In general, user instructions direct the operation of the information retrieval and processing component 202, and result in the display, within one or more cells, information resulting from these operations.

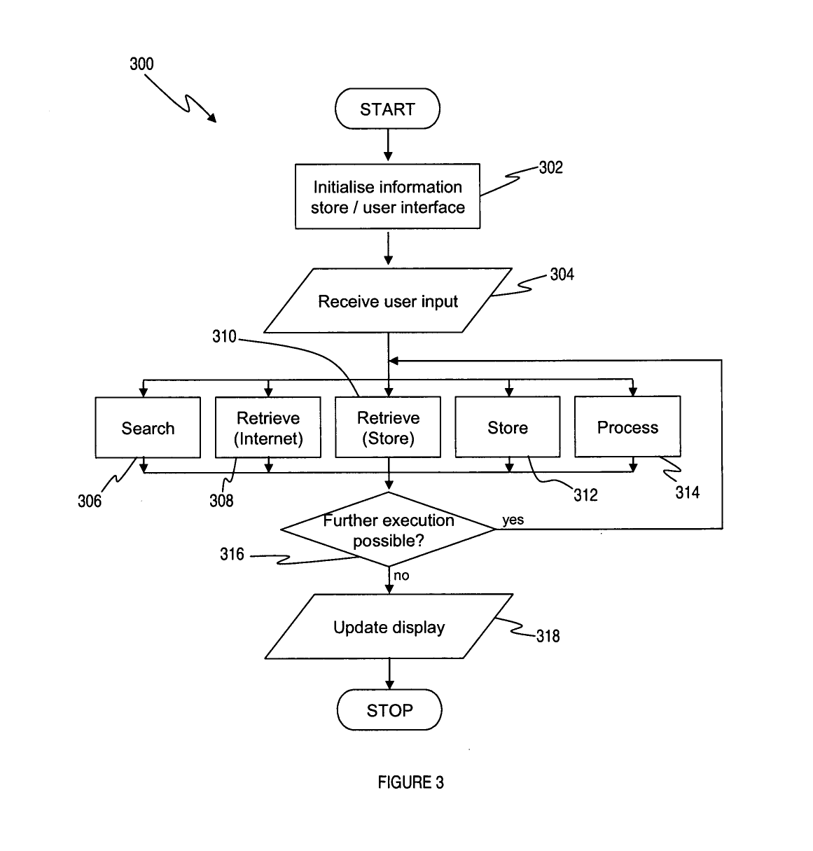

FIG. 3 depicts a flowchart 300 illustrating a method of retrieval and manipulation of information, such as may be implemented within the computer 102, and in accordance with the software architecture 200. In the initial step 302, any appropriate initialisation of the information store 220, 114 and the user interface 204 is performed.

At step 304, user input is received into the user interface 204 via the input device 122. Appropriate user input triggers further searching, retrieval, storage and information processing functions of the software component 202. In particular, responsive to user input 304, one or more of the following retrieval or processing operations may be executed:
performance of a search 306, responsive to a user query, via a search engine 106;
retrieval of information 308, for example from a feed server 108 or Web server 110, typically associated with prior search results;
retrieval of information 310 from storage 114, typically corresponding with the results of earlier retrieval 308 via the Internet 304;
storage of retrieved results 312, within the local store 114; and/or
processing or manipulation 314 of any of the aforementioned search results and/or retrieved information sources.

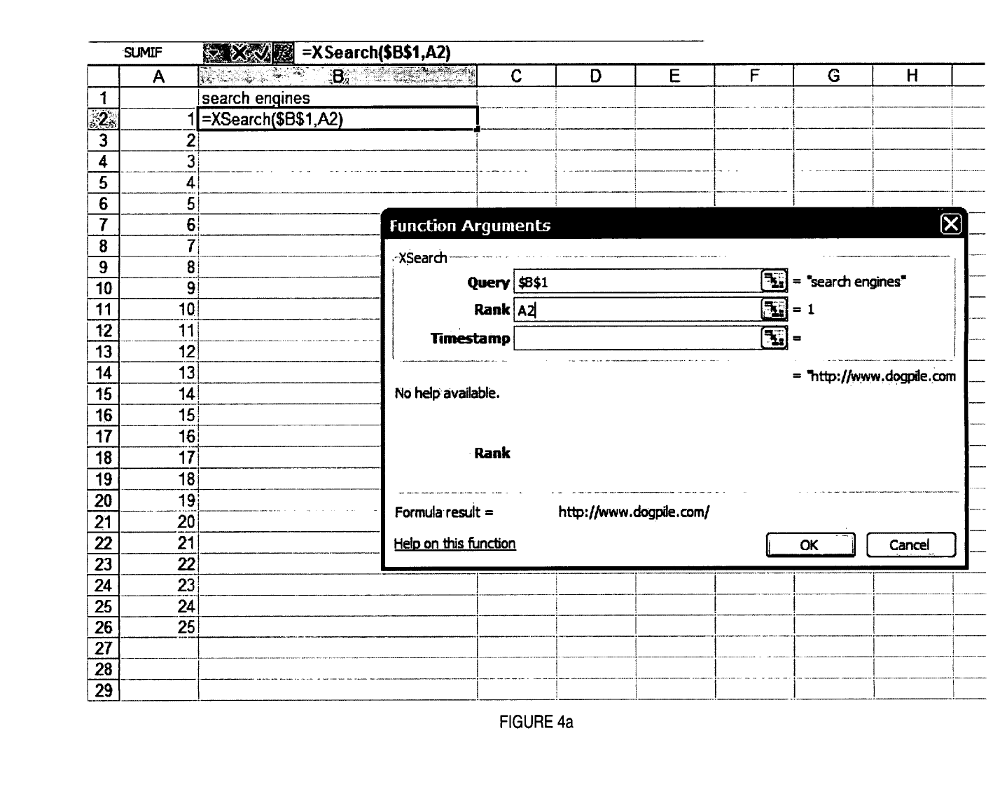

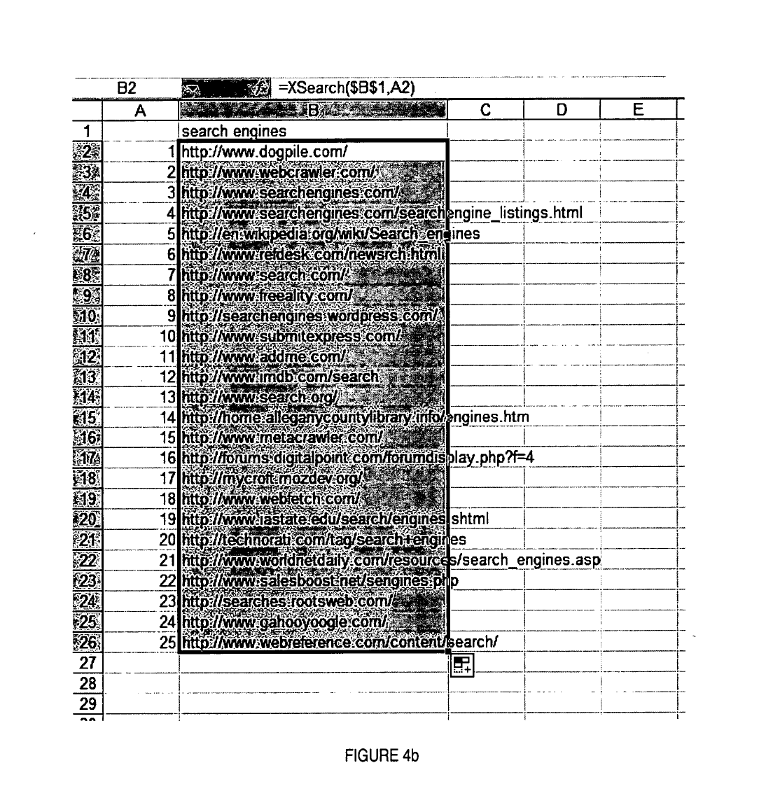

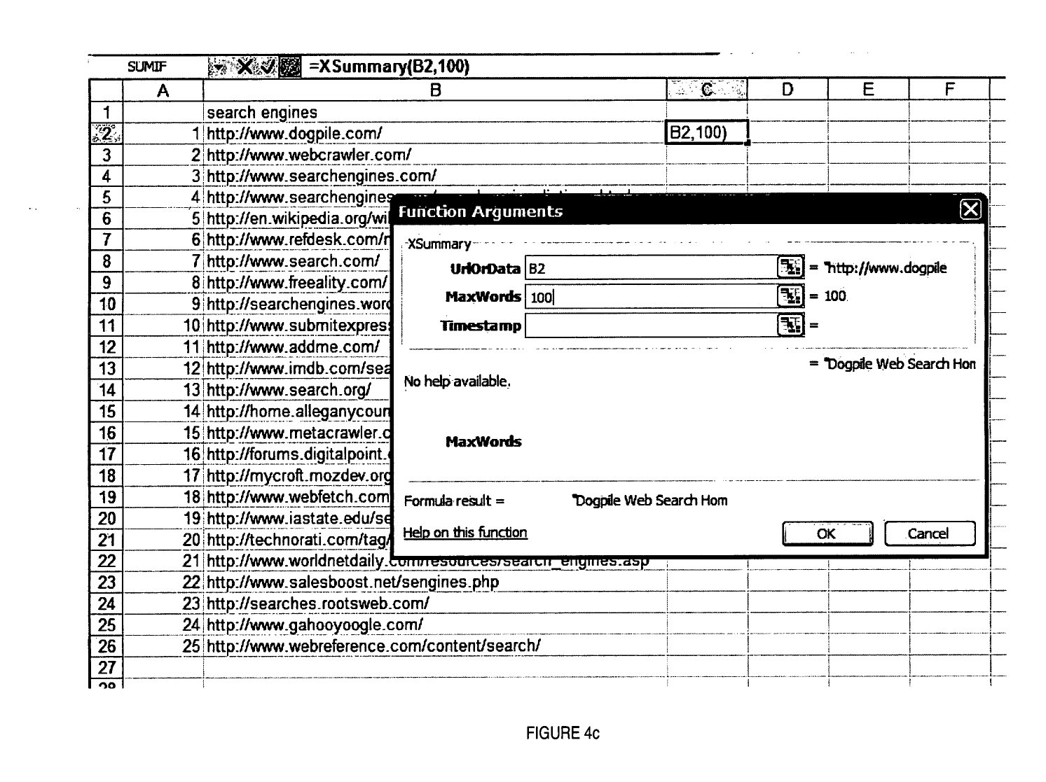

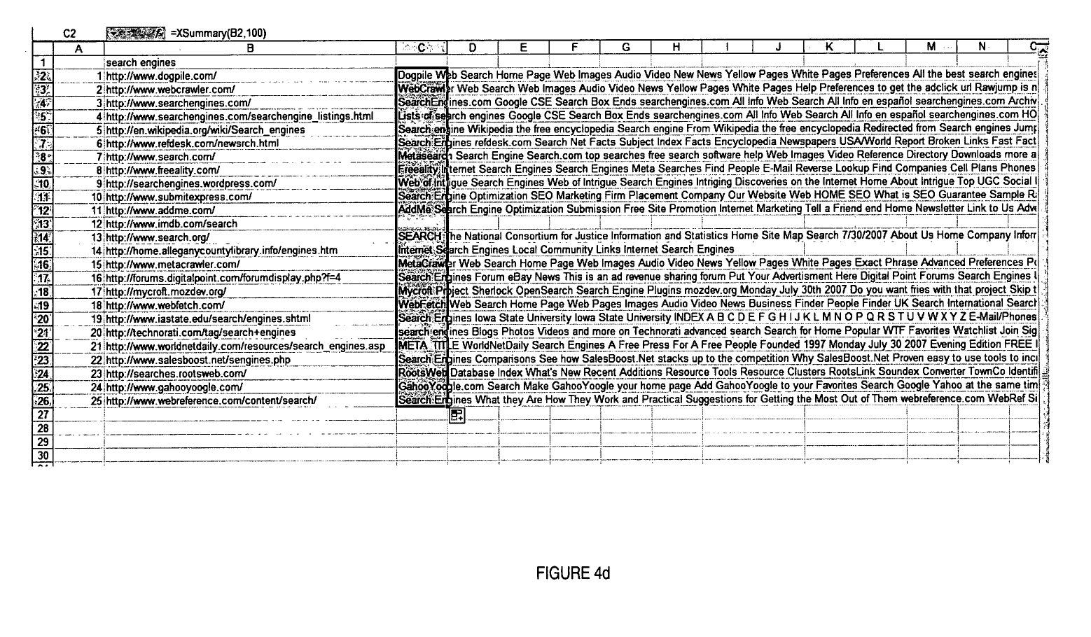

In accordance with the preferred embodiment, and as will be illustrated by way of the examples described below with reference to FIGS. 4 to 7, the user interface 204 provides a two-dimensional matrix of input/output cells, and operates in a manner similar to known spreadsheet applications. In particular, in accordance with this model there may be interdependencies between cells in the array. For example, the results of a searching step 306 may provide a list of references (eg URLs) which may be in turn used as the basis for a retrieval step 308, a storage step 312, and further processing 314. Stored results may subsequently be retrieved 310 for use in other input/output cells. Execution of the various information retrieval and processing operations should preferably only cease when no further execution is possible, ie when all dependencies between cells have been accounted for. Execution engines capable of handling such interdependencies, and efficiently performing all required operations in an optimal sequence, are known in the prior art, and are provided, for example in commercially available spreadsheet applications.

Accordingly, at step 316 a suitable execution engine determines whether further execution of operations is possible and/or necessary. If so, then further steps 306, 308, 312 and/or 314 may be executed. Otherwise, at step 318 the display of the user interface 204 is updated to reflect the results of all completed operations.

As noted above, the execution control necessary to implement the invention is already provided in commercially available spreadsheet applications.

Accordingly, a preferred embodiment of the invention, as described herein, is implemented as add-in functionality to the widely deployed Microsoft Excel spreadsheet product. In particular, the embodiment subsists substantially in a software component 202 which is interfaced to the executing Excel program, within the Microsoft Windows environment, as a dynamically linked library (DLL).

As will be known to those skilled in the art of programming within this environment, Microsoft Excel allows for additional functions to be added via the DLL mechanism. In particular, appropriate program code is written, and then compiled to a DLL module. The DLL is subsequently loaded by the running Microsoft Excel application, which enumerates the various symbols (ie function names) identified within the DLL, and corresponding with executable program code therein. By this mechanism, any number of new functions, having programmer-defined names, and performing operations determined by the corresponding program code, may be added. Each programmer-defined function provided within the DLL may accept one or more parameters or arguments, which may be accessed from within the Excel environment using a published API, which will be readily ascertained by those skilled in the relevant programming arts.

Accordingly, in the preferred embodiments, various add-in functions of the information retrieval and processing component 202 have been implemented, a number of which are described below, and then subsequently illustrated with specific examples, having reference to FIGS. 4 to 7.

### Exemplary Functions

The various functions implemented within a DLL add-in to Microsoft Excel, in accordance with the exemplary embodiment of the present invention, include functions for connecting to programmable APIs of Web search engines for the purposes of carrying our search queries, to download information feeds (in common formats such as Atom or RSS) and parse the output into individual items, and to download individual documents, possibly referenced in search engine results, as well as for performing various information processing functions on such retrieved information.

The exemplary embodiment provides a number of functions which operate with respect to searching and retrieval within the networked environment 100. These functions are identified below, by name and parameter listing, followed by a brief description of the operation of each.

DesktopSearch (Query, Rank, Timestamp)

The Desktop Search function returns the URL for a result, identified by the numerical parameter “rank”, of a desktop search for the text parameter “query”. For example, if the search returns eight documents, and the value of the parameter “rank” is 4, then the URL of the fourth result out of eight is returned. The function endeavours to return results applicable at a time that is as close as possible to “timestamp”. The use of timestamping within preferred embodiments of the invention is described in greater detail below.

FeedItem (DataSource, Index, Timestamp)

The FeedItem function returns the URL of the item number “index” from a structured feed, eg RSS or Atom, provided by “dataSource”, being a reference to the feed, as close as possible to the time specified by “timestamp”.

Fetch (DataSource, Timestamp)

The Fetch function retrieves the raw content of the information identified by “dataSource”, as close as possible to the time specified by “timestamp”. A dataSource may be, for example, the URL of a specific Web page, in which case the returned content is the HTML code associated with the Web page.

Search (Query, Rank, Timestamp)

The Search function conducts a search using an external search engine (or, indeed, several search engines), and returns the URL corresponding with result number “rank” as close as possible to the time specified by “timestamp”. Such a search is typically similar to the kind of search that may be conducted manually, for example using the Web-based interface of a search engine such as Google. As is well-known, such searches typically return a list of results, in a rank order determined by rules implemented within the search engine. Ranking is based on search-engine-specific algorithms which are intended to list results considered to be “most relevant” to the search query first, with less relevant results following. The top result therefore has a “rank” value of 1, and the “rank” parameter may be used to select this, or any subsequent result.

The use of timestamps, in conjunction with the store 114, is now discussed in greater detail. Information returned by any of the aforementioned functions from the “live” system (ie from the desktop, or via the Internet 104, at the date and time of execution of the function) is stored within the data store 114, along with an associated time stamp corresponding with the time of retrieval of the information. Any subsequent operation, including operation of the aforementioned functions, which requires the same information, at (or approximately at) the same time, accordingly does not require further retrieval of results or content. Rather, relevant information can be obtained/retrieved from the store 114. If the “timestamp” parameter is omitted, then it is assumed that the results/content are to be obtained corresponding with the present time. Functions executed with a particular value for the “timestamp” parameter return results corresponding, as closely as possible, with the requested timestamp. However, it will be understood that unless corresponding information is held within the store 114, the best that can be done may be to retrieve information from the “live” system. In general, therefore, the acquisition and analysis of historical information is dependent upon the user conducting appropriate periodic enquiries, in order to populate the store 114 with the required historical information.

As a further effect of the use of local storage, multiple operations or functions within a single array of cells (ie spreadsheet), will not necessarily require multiple remote retrieval operations. For example, if the “Search (query, rank)” function is executed in association with one cell, a number of results will be returned from the search engine and cached in the store 114. These results will typically be in the form of URLs and corresponding text summaries, as provided by the API of the search engine. The result number “rank” is then requested, and may be used, for example, as the “dataSource” parameter of a subsequent Fetch function. If another cell has a reference to a search for the same query, but different rank, there is no need to repeat the search, because the results have been cached locally.

A number of information processing/manipulation functions provided in the exemplary embodiment are now summarised.

Anchors (DataSource, Index, Timestamp)

The Anchors function returns the “anchor text” for the link numbered “index” within the document identified by “dataSource”. As will be appreciated by those skilled in the art of Web document authoring or development, “Anchor text” is the displayed text associated with a hyperlink in an HTML document.

Crawl (DataSource, Index, Timestamp)

The Crawl function again relates to the link number “index” within a source document identified by “dataSource”, and fetches the raw data (eg HTML source code) corresponding with the dataSource.

HtmlXpath (DataSource, Xpath, Timestamp)

By interpreting the content referenced by “dataSource” as HTML, the HTMLXpath function returns the string occurring at location “xpath” within the data.

Links (DataSource, Index, Timestamp)

The Links function returns the actual URL corresponding with the Link number “index” within the document “dataSource”.

NamedEntity (DataSource, Type Index, Timestamp)

The NamedEntity function returns the entity number “index” of the specified “type” within the document identified by “dataSource”.

Rank (DataSourceCollection, Query, Index, Timestamp)

The Rank function ranks each “dataSource” (eg Web page) in “dataSourceCollection” (eg a corpus of Web pages) in accordance with the “query”, and returns element number “index”.

Selection (DataSource, Query, Index, ParagraphOrSentence, Timestamp)

The Selection function ranks each paragraph or sentence in the document referenced by “dataSource” according to “query”, and returns the result number specified by “index”.

Snippet (DataSource, Query, MaxWords, Timestamp)

The Snippet function returns a series of snippets (ie portions of text illustrating the context of “query” within a document) from the document referenced by “dataSource”, with the Snippet including a maximum of “maxWords” words.

Summary (DataSource, MaxWords, Timestamp)

The Summary function retrieves summary text from the source (eg HTML document) referenced by “dataSource”, up to a maximum length of “maxWords”.

Text (DataSource, Timestamp)

The Text function, as the name implies, returns a version of the document “dataSource”, which may generally be a formatted document such as a Web page, with all formatting information stripped.

XmlXpath (DataSource, Xpath, Timestamp)

The XmlXpath function is similar to the HTML xpath function, except that “dataSource” is interpreted as an XML document.

As will be noted, all of the foregoing functions include a timestamp parameter, which operates in the manner previously described.

The foregoing functions are by no means an exhaustive set of the operations which a knowledge worker might wish to use when manipulating information. Rather, they are indicative of common activities required when dealing with Web information and basic text documents, and those skilled in the art will note that they correspond with functions appearing in the programmatic APIs that have formerly only been available to experienced programmers.

A number of examples will further illustrate the features and advantages of the exemplary embodiments of the present invention. As previously noted, the exemplary embodiment is implemented as an add-in to Microsoft Excel, and accordingly users of this popular spreadsheet application will find the general features of the interface to be reasonably familiar. The following discussion, therefore, focuses only on the use of the add-in functionality, which accords with the present invention. It will also be noted that in the following examples each of the foregoing function names is preceded by a capital X, to avoid conflict with existing internal Excel functions. While this will be apparent from the exemplary screenshots, the initial letter X is omitted from the description.

### EXAMPLE 1

### Interacting With Search Results

FIGS. 4a to 4d are screenshots demonstrating simple interaction with search results according to the exemplary embodiment.

FIG. 4a shows the entry of a query, for the search term “search engines” using the Search function. In particular, the Search function is entered in cell B2 of a spreadsheet, receiving the “Query” parameter from cell B1, and the “Rank” parameter from cell A2. Thus the first-ranked search result for the term “search engines” is returned, and displayed in cell B2. This is illustrated in FIG. 4b, in which cell B2 has been extended vertically down to cell B26, resulting in the corresponding cells of the spreadsheet being populated with the first 25 search results for the term “search engines”.

FIG. 4c illustrates the use of the Summary function, wherein the “dataSource” parameter is drawn from the search result in cell B2, and the “maxWords” parameter is set to 100. FIG. 4d shows the resulting summary text populating column C of the spreadsheet.

### EXAMPLE 2

### Interacting With RSS/Atom Feed Items

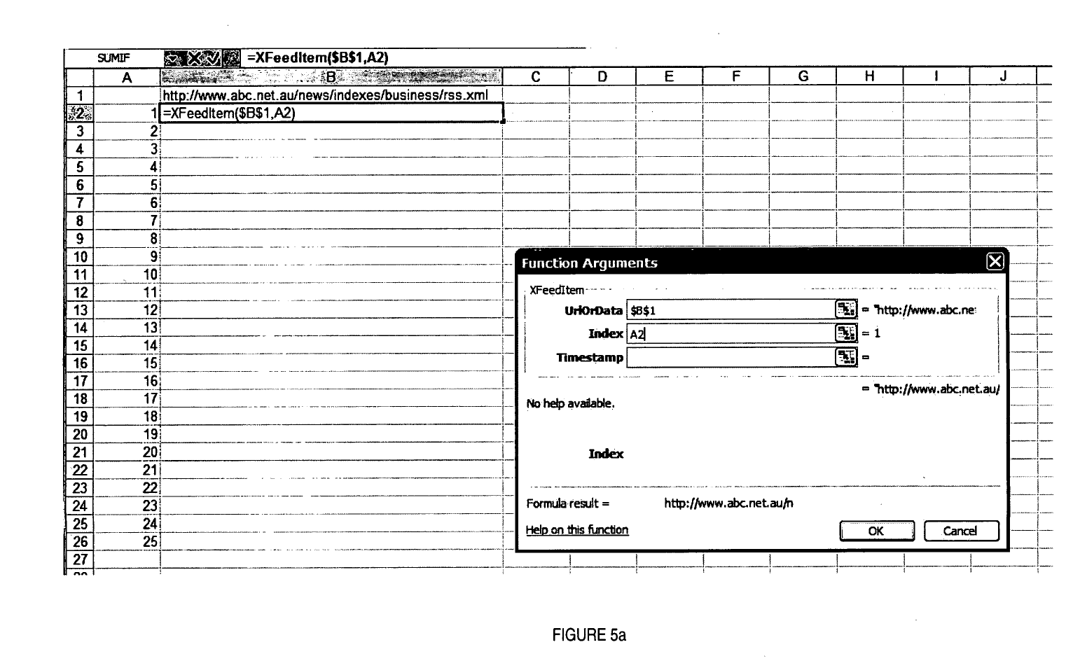

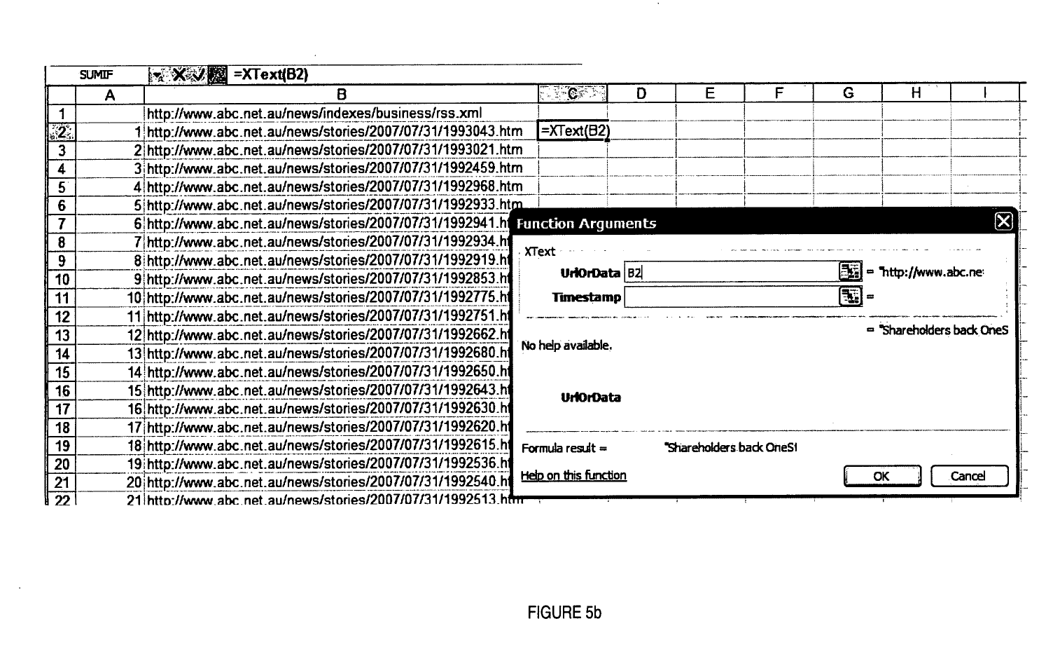

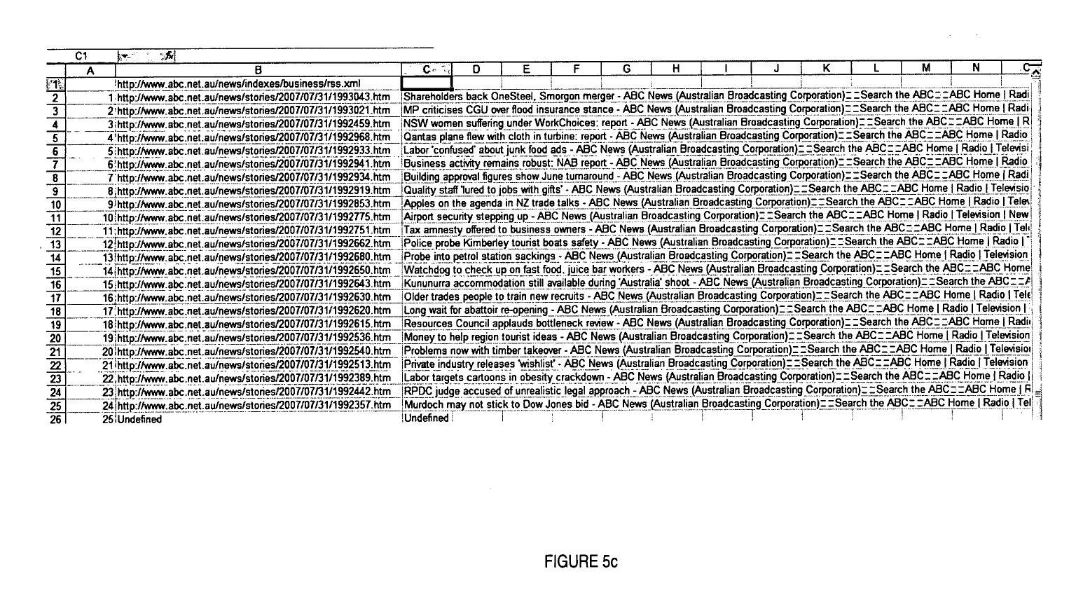

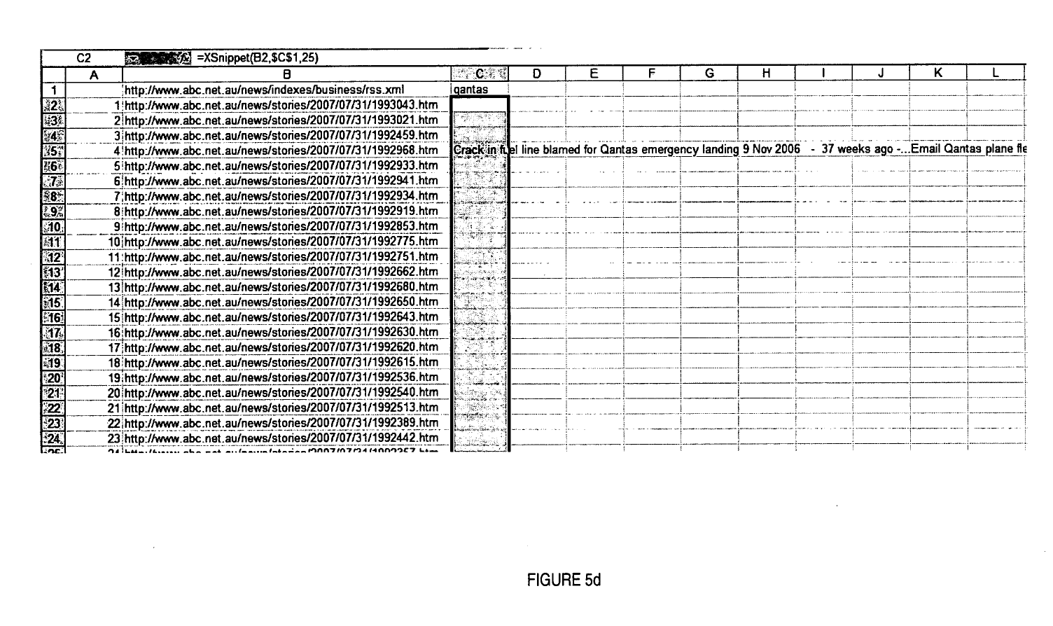

FIG. 5a is a screenshot of a spreadsheet in which cell B1 has been populated with the URL of an RSS news feed. The FeedItem function is entered in cell B2, taking its “dataSource” parameter from cell B1, and its “index” parameter from cell A2, which contains the number 1. As illustrated in FIG. 5b, cell B2 is then extended to fill column B down to cell B26. This results in specific URLs corresponding with the top 25 items in the RSS feed being returned, and populating the cells of column B.

As further illustrated in FIG. 5b, the text function is used in cell C2 in order to retrieve the plain text corresponding with the top item in the RSS feed, the URL of which is now contained in cell B2. FIG. 5c illustrates the results of extending this function down to cell C26.

FIG. 5d illustrates the use of the Snippet function in column C, in place of the Text function, to return context for the term “Qantas”, which has been entered into cell C1. The term “Qantas” appears in the fourth item of the RSS feed, and accordingly corresponding context is displayed in cell C5.

### EXAMPLE 4

### Interacting With RSS/Atom Feed Items Over a Period of Time

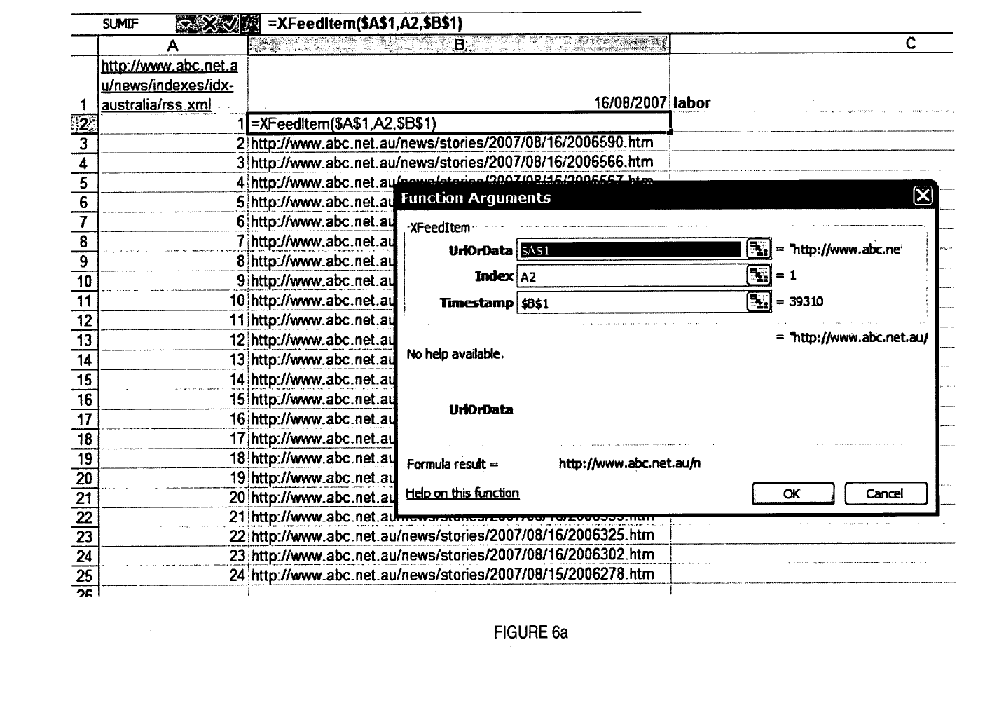

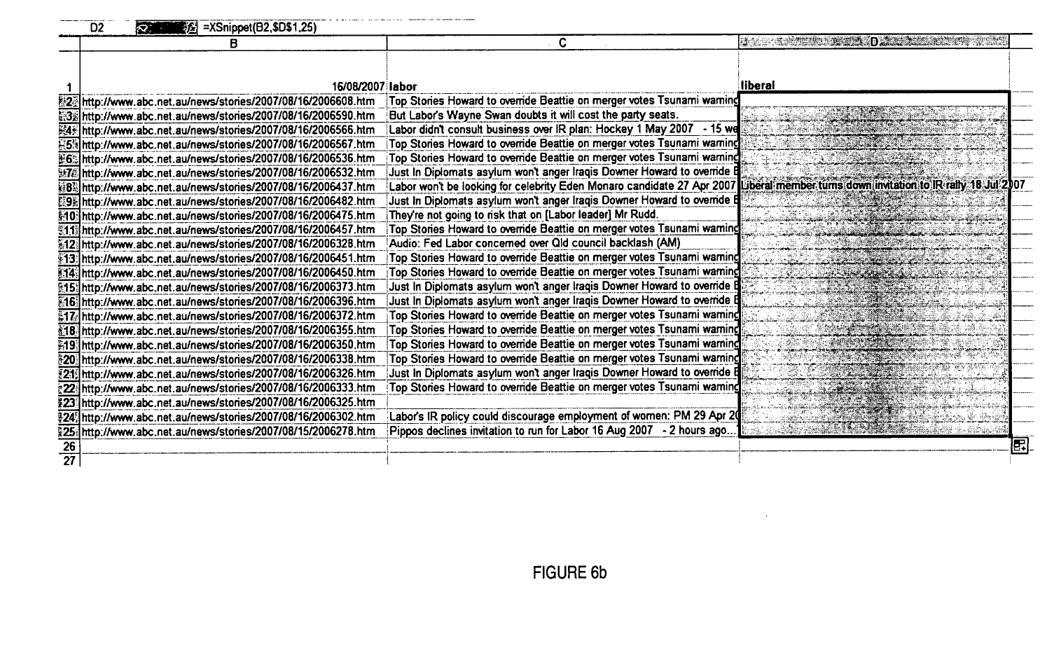

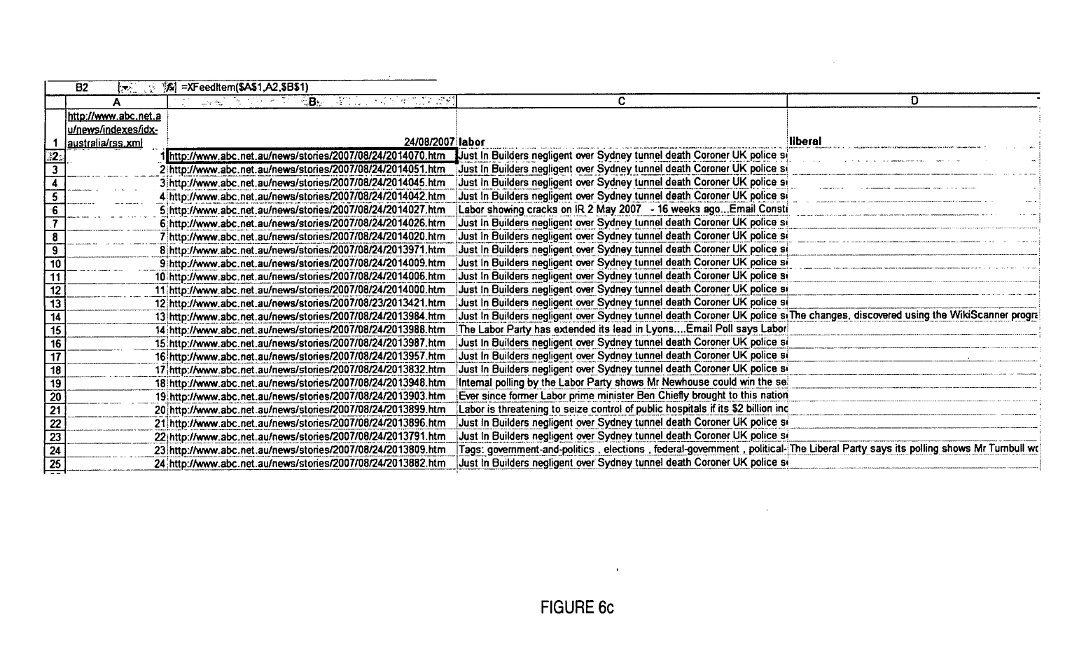

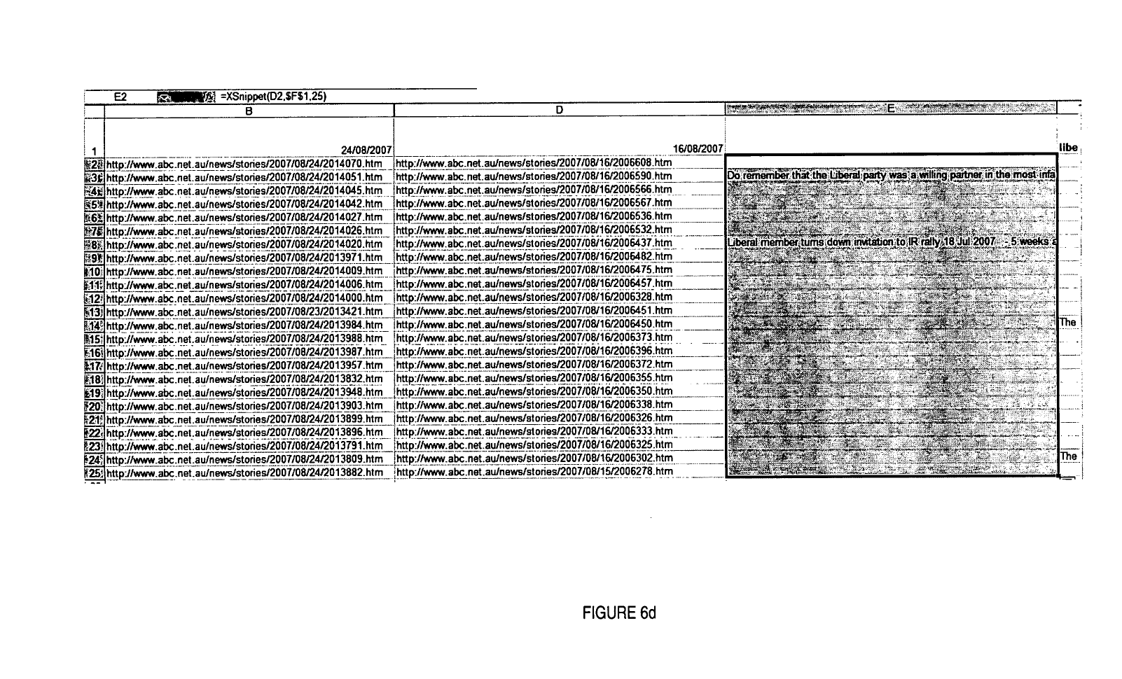

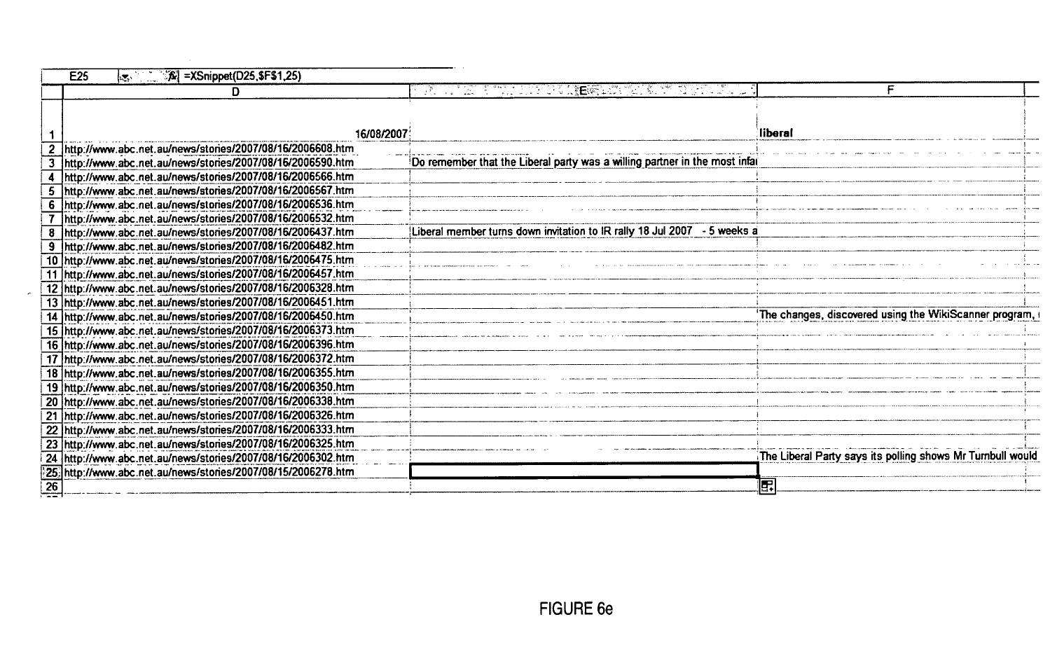

FIGS. 6a and 6b show a spreadsheet in which cell A1 has been populated with the URL of an RSS feed, cell 81 has been populated with a date (16 Aug. 2007) and cells C1 and D1 have been populated with the text terms “labor” and “liberal”.

As illustrated in FIG. 6a, in cell B2 the FeedItem function is used to retrieve the first item of the RSS feed, corresponding with the date in cell B1. This function has then been extended to cell B25.

In FIG. 6b, the use of the Snippet function is illustrated, in conjunction with the terms “labor” and “liberal”. In column C, alongside the FeedItem URLs, Snippets showing context for the word “labor” are displayed. Alongside, in column D, snippets showing context for the term “liberal” in respect of each viewed item are displayed.

Persons skilled in the use of spreadsheet applications will recognise that changing the source data appearing row 1 will cause the changes to propagate to dependent cells within the spreadsheet. This is illustrated in FIG. 6c, in which the date in cell B1 has been changed to 24 Aug. 2007. As a result, the feed URLs and corresponding snippets have also changed.

As previously described, all of the earlier results, corresponding with the retrievals conducted on 16 Aug. 2007, are still held within the store 114. It is therefore possible, as illustrated in FIGS. 6d and 6e to retrieve and process the results corresponding with the earlier timestamp, and, for example, compare the references to the term “liberal” on the two different dates, as in FIG. 6e.

### EXAMPLE 4

### Interacting With Web Pages Over Time

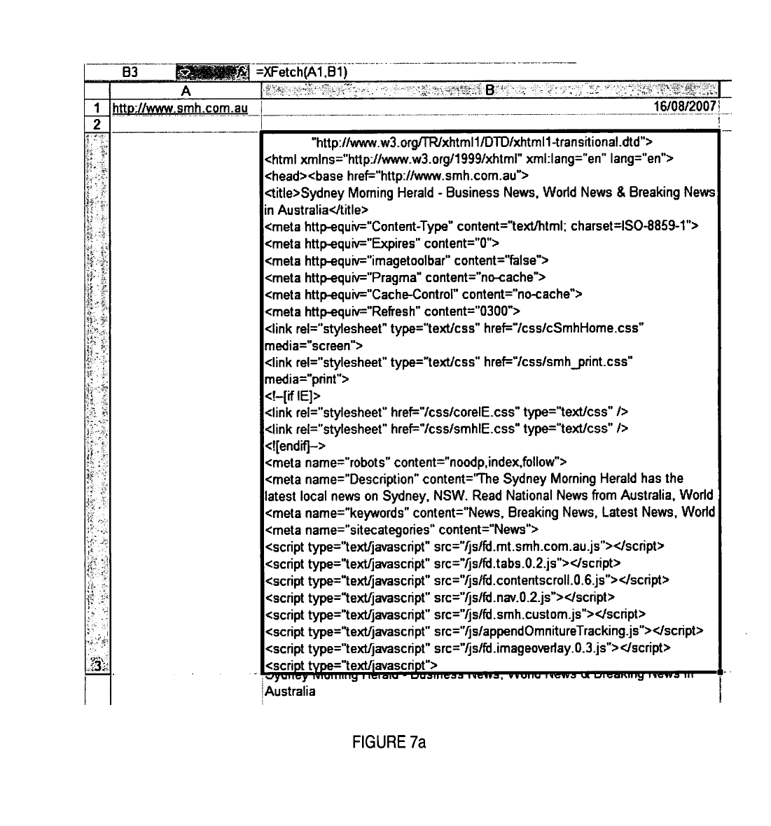

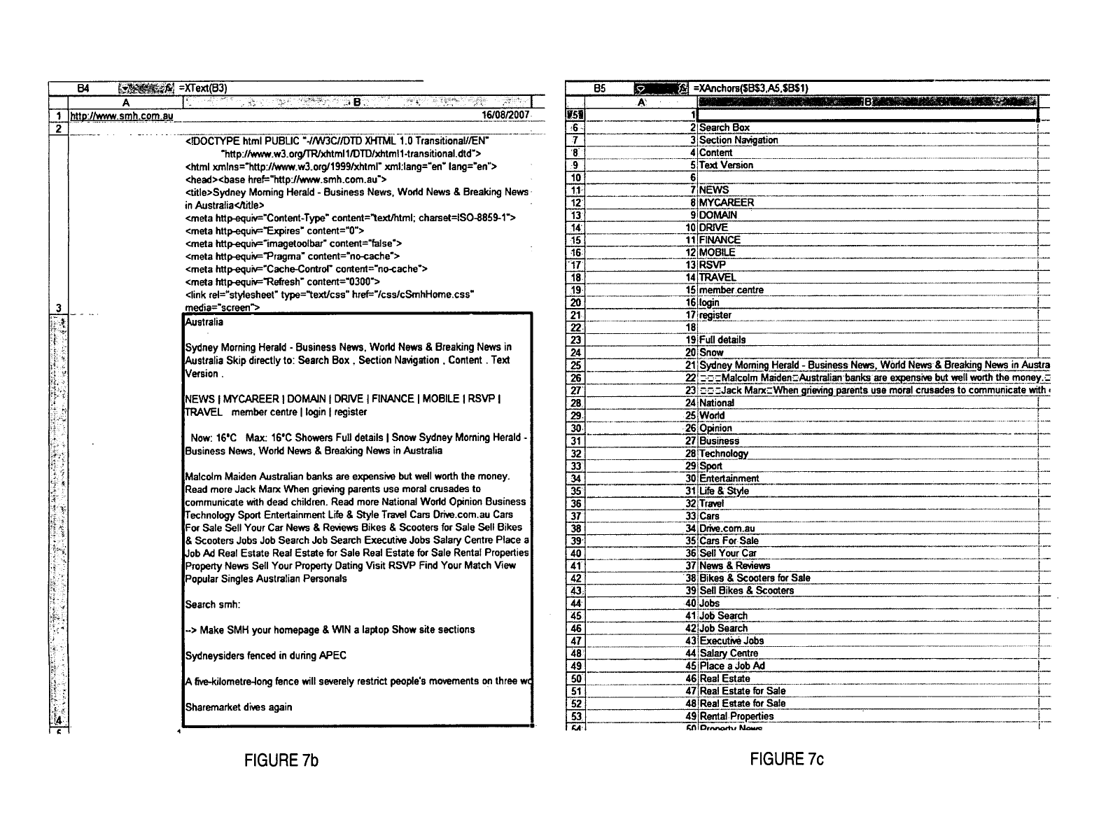

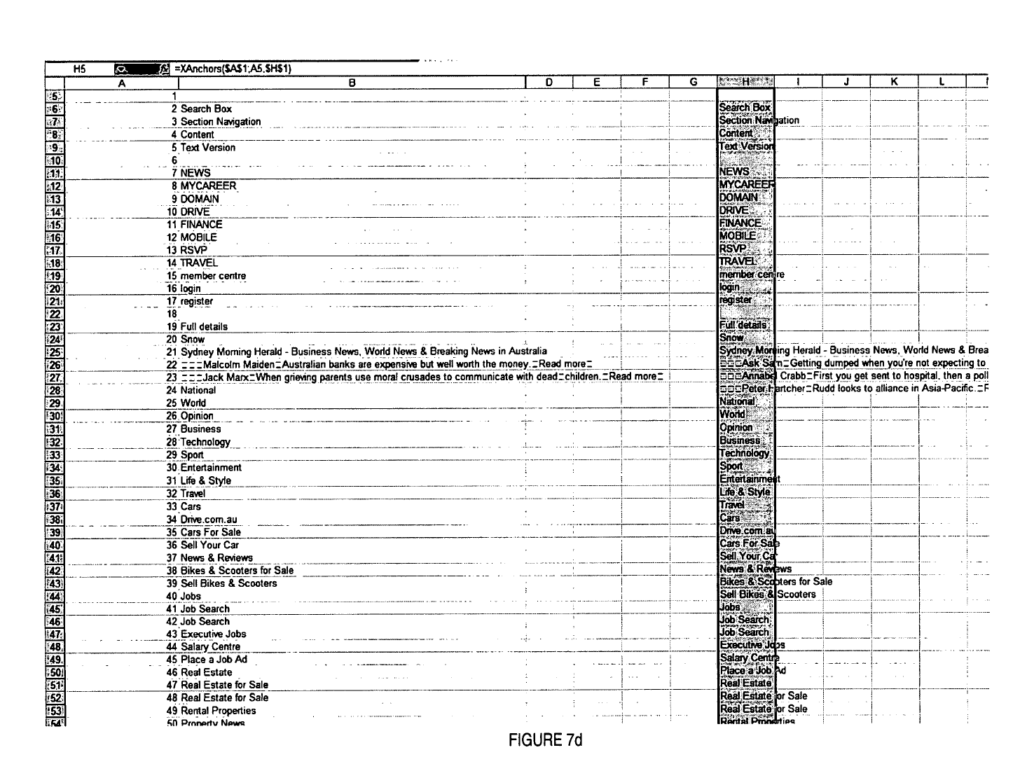

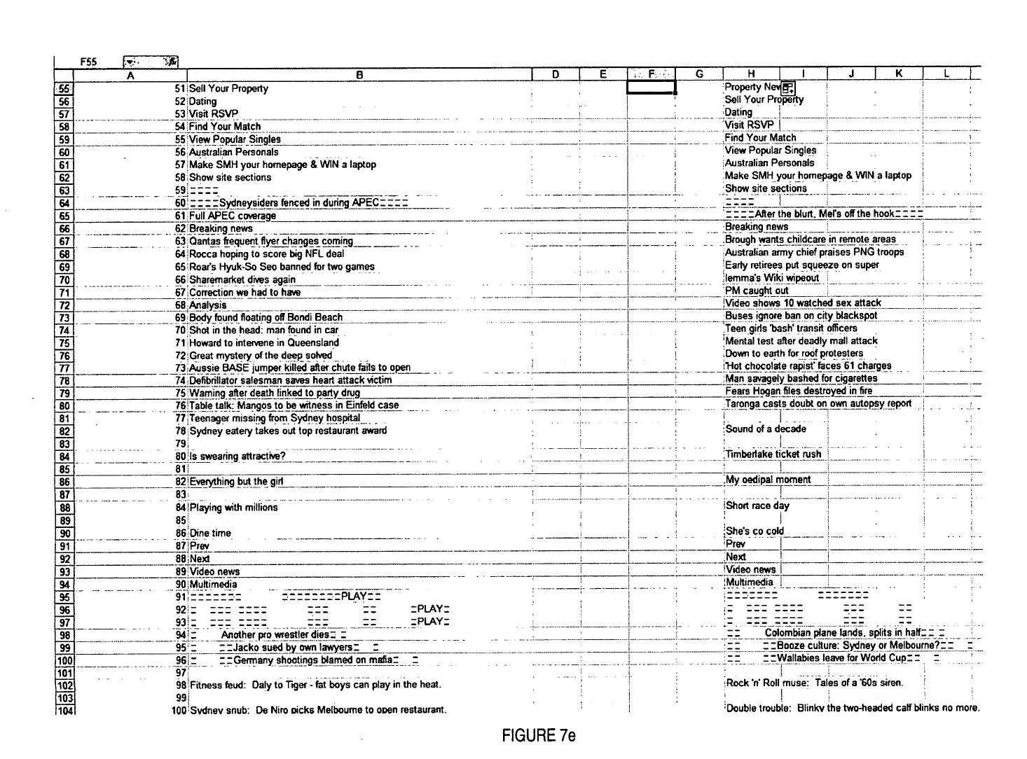

FIG. 7a illustrates a spreadsheet in which cell A1 has been populated with the URL of a specific Web site. Cell B1 has been populated with a date, namely 16 Aug. 2007. In cell B3, the Fetch function is used to retrieve the source document (ie HTML) corresponding with the Web page identified in cell A1. FIG. 7b illustrates the use of the Text function to strip the formatting from the HTML in cell B3. FIG. 7c illustrates the use of the Anchors function to extract the Anchor text corresponding with the various links appearing within the Web page.

In like manner to the previous example, involving the interaction with feeds over time, the date in cell B1 may be updated to retrieve results corresponding with a more recent date, as part of a series of retrievals. In the example, the aforementioned operations have been repeated on 24 Aug. 2007, enabling the Anchor text appearing on the Web page at the two different dates to be compared side-by-side, as illustrated in FIGS. 7d and 7e. It can be seen that the general structure of the Web page remains the same, however Anchors corresponding with specific articles that change on a daily basis have changed.

It is once again emphasised that the foregoing described embodiments of the invention are intended to be exemplary only, and should not be considered limiting of the scope of the invention, as defined in the following claims.

What is claimed is:

1. A computer-implemented system for the retrieval and manipulation of information available via an information network, the system including:
an information retrieval and processing component, which includes:
search query means for conducting a search of the information network to obtain references to information relevant to a search query;
information retrieval means for retrieving information available from sources on the information network, corresponding with said references;
an information store, for storage of retrieved information; and
processing means for processing of information retrieved from said sources on the information network and of information stored in said information store, to produce corresponding processed information; and
a user interface having an array of input/output cells, which is adapted to enable a user to provide input into one or more of said cells for directing operations of the information retrieval and processing component, and to display within one or more of said cells information resulting from said operations.

2. The system of claim 1 wherein the array of input/output cells includes at least a two-dimensional matrix of cells.

3. The system of claim 1 wherein information is associated with cells in the array, and the processing means is adapted to process said associated information.

4. The system of claim 3 wherein the search query means is adapted to retrieve results of a user-provided search query, and to associate one or more of said results with a corresponding one or more cells in the array.

5. The system of claim 3 wherein the information retrieval means is adapted to retrieve information from sources in the information network, or in the information store, and associate said retrieved information with one or more cells in the array.

6. The system of claim 1, wherein the information retrieval and processing component is adapted to store search results obtained by the search query means, and information retrieved by the information retrieval means, in the information store.

7. The system of claim 6 wherein information in the information store is associated with a timestamp identifying a corresponding time of retrieval.

8. The system of claim 7 wherein the processing means is adapted to process information stored in the information store and/or information currently available via the information network, in accordance with a user-specified time specification.

9. The system of claim 1, wherein input provided by a user includes instructions in the form of named functions having corresponding input parameters, which direct the information retrieval and processing component to perform corresponding operations.

10. The system of claim 9 wherein the functions include search functions, information retrieval functions and information processing functions.

11. The system of claim 9 wherein an input parameter to a function associated with a first cell of the array includes one or more references to results of functions associated with one or more further cells of the array.

12. The system of claim 11 wherein the information retrieval and processing components include an execution engine adapted to effect steps for determining an appropriate evaluation order arising from dependencies between said first cell of the array and said one or more further cells of the array, and to repeatedly execute corresponding functions in a required evaluation order, until no further execution is possible.

13. The system of claim 1, wherein the information retrieval and processing component is implemented within a spreadsheet application.

14. An apparatus for the retrieval and manipulation of information available via an information network, the apparatus including:
at least one microprocessor;
at least one memory/storage device operatively associated with the microprocessor;
at least one network interface device providing a connection to the information network and operatively associated with the microprocessor;
at least one user input device operatively associated with the microprocessor; and
at least one display device operatively associated with the microprocessor,
wherein the memory/storage device includes executable instruction code which, when executed by the microprocessor, causes the apparatus to implement the steps of:
displaying, on said display device, a graphical user interface having an array of input/output cells;
receiving input of a user via said user input device, said input being associated with one or more of said cells, and including instructions relating to the retrieval and processing of information available via the information network;
responsive to said user input, performing one or more information retrieval or processing operations selected form the group consisting of:
conducting a search of the information network to obtain references to information relevant to a search query of the user;
retrieving information from sources on the information network corresponding with said references;
retrieving information from the information store corresponding with said references;
storing information retrieved from sources on the information network within the information store; and
processing information retrieved from said sources on the information network or information stored in said information store, to produce corresponding processed information; and
displaying within one or more of said cells information resulting from said retrieval or processing operations.

15. A computer-implemented method for retrieval and manipulation of information available via an information network, the method including the steps of:
providing an information store for storage of information retrieved from the information network;
providing a user interface having an array of input/output cells;
receiving input of a user into one or more of said cells, said input including instructions relating to the retrieval and processing of information available via the information network;
responsive to said user input, performing one or more information retrieval or processing operations selected from the group consisting of:
conducting a search of the information network to obtain references to information relevant to a search query of the user;
retrieving information from sources on the information network corresponding with said references;
retrieving information from the information store corresponding with said references;
storing information retrieved from sources on the information network within the information store; and
processing information retrieved from said sources on the information network or information stored in said information store, to produce corresponding processed information; and
displaying within one or more of said cells information resulting from said retrieval or processing operations.
